(19) United States
(12) Patent Application Publication
(10) Pub. No.: US 2021/0407753 A1
(43) Pub. Date: Dec. 30, 2021

(54) ELECTROMAGNETIC SWITCH DEVICE

(71) Applicant: Mitsubishi Electric Corporation, Tokyo (JP)

(72) Inventors: Takuma ONO, Tokyo (JP); Koichiro KAMEI, Tokyo (JP)

(73) Assignee: Mitsubishi Electric Corporation, Tokyo (JP)

(21) Appl. No.: 17/281,471

(22) PCT Filed: Nov. 9, 2018
(86) PCT No.: PCT/JP2018/041689

§ 371 Date: Mar. 30, 2021

(51) Int. Cl. H01H 50/18; H01H 50/44; H01H 50/02

(52) U.S. Cl. CPC H01H 50/18; H01H 50/02; H01H 50/44

(57) ABSTRACT

An electromagnetic switch device includes: a fixed iron core; a plunger configured to move between a contact position and a separation position; a suction coil configured to generate, with a current supplied thereto, a magnetic field configured to move the plunger from the separation position toward the contact position; and a holding coil configured to generating, with a current supplied, a magnetic field configured to move the plunger from the separation position toward the contact position and a magnetic field configured to keep the plunger in the contact position. The holding coil is arranged in such a manner as to deviate, in a moving direction of the plunger, with respect to a contact surface of the fixed iron core.

### TECHNICAL FIELD

This invention relates to an electromagnetic switch device to be used for, for example, a starter for starting an automobile engine.

### BACKGROUND ART

Hitherto, there has been known an electromagnetic switch device including a fixed iron core and a plunger. The fixed iron core is made of a magnetic material. The plunger is made of a magnetic material and is configured to move between a contact position and a separation position. The contact position is a position for allowing the plunger to be in contact with the fixed iron core. The separation position is a position for allowing the plunger to be apart from the fixed iron core. This electromagnetic switch device further includes a suction coil and a holding coil. The suction coil is configured to generate, with a current supplied thereto, a magnetic field configured to move the plunger from the separation position to the contact position. The holding coil is configured to generate, with a current supplied thereto, a magnetic field configured to keep the plunger at the contact position. When the operation of the electromagnetic switch device is started, the current is supplied to each of the suction coil and the holding coil, and the plunger is configured to move from the separation position to the contact position. The supply of the current to the suction coil is stopped before the plunger reaches the contact position, and then the plunger is brought to the position corresponding to the contact position by only the magnetic field generated by the holding coil (see, for example, Patent Literature 1).

### CITATION LIST

### Patent Literature

[PTL 1] WO 2017/187493 A1

### SUMMARY OF INVENTION

### Technical Problem

However, the holding coil is arranged on the same plane as a contact surface of the fixed iron core with which the plunger comes into contact. Therefore, as the plunger approaches the fixed iron core, the amount of the magnetic flux passing through the gap between the plunger and the fixed iron core becomes larger. With this, as the plunger approaches the fixed iron core, a suction force that is a force for moving the plunger toward the fixed iron core becomes larger. As a result, there is a problem in that an impact force to be generated between the plunger and the fixed iron core when the plunger comes into contact with the fixed iron core becomes larger.

This invention has been made to solve the above-mentioned problem, and has an object to provide an electromagnetic switch device capable of reducing an impact force to be generated between a plunger and a fixed iron core when the plunger comes into contact with the fixed iron core.

### Solution to Problem

According to this invention, there is provided an electromagnetic switch device, including: a fixed iron core; a plunger configured to move between a contact position and a separation position, the contact position being a position for allowing the plunger to be in contact with the fixed iron core, the separation position being a position for allowing the plunger to be apart from the fixed iron core; a suction coil configured to generate, with a current supplied thereto, a magnetic field configured to move the plunger from the separation position toward the contact position; and a holding coil configured to generate, with a current supplied thereto, a magnetic field configured to keep the plunger in the contact position, wherein the holding coil is arranged in such a manner as to deviate, in a moving direction of the plunger, with respect to a contact surface of the fixed iron core with which the plunger comes into contact.

### Advantageous Effects of Invention

In the electromagnetic switch device according to this invention, the holding coil is arranged in such a manner as to deviate, in the moving direction of the plunger, with respect to the contact surface of the fixed iron core. Therefore, the amount of magnetic flux passing through the gap between the plunger and the fixed iron core is reduced immediately before the plunger is brought into contact with the fixed iron core. With this, the suction force for moving the plunger toward the fixed iron core is reduced immediately before the plunger comes into contact with the fixed iron core. As a result, the impact force to be generated between the plunger and the fixed iron core when the plunger comes into contact with the fixed iron core can be reduced.

### BRIEF DESCRIPTION OF DRAWINGS

FIG. 1 is a configuration diagram for showing a starter in which an electromagnetic switch device according to a first embodiment of this invention is used.

FIG. 2 is a cross-sectional view for illustrating a main part of the starter of FIG. 1.

FIG. 3 is a diagram for showing a magnetic flux to be generated by a holding coil in an electromagnetic switch device of a comparative example immediately before a plunger collides with a fixed iron core.

FIG. 4 is a diagram for showing a magnetic flux to be generated by the holding coil in the electromagnetic switch device of FIG. 2 immediately before the plunger collides with the fixed iron core.

FIG. 5 is a graph for showing a relationship between the suction force and a gap in the electromagnetic switch device of FIG. 2.

FIG. 6 is a configuration diagram for showing a modification example of the starter of FIG. 1.

### DESCRIPTION OF EMBODIMENTS

### First Embodiment

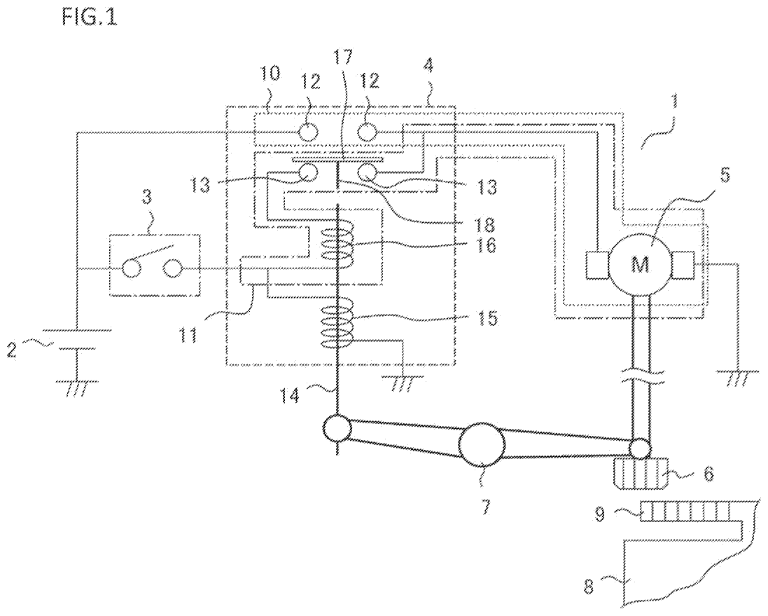

FIG. 1 is a configuration diagram for showing a starter in which an electromagnetic switch device according to a first embodiment of this invention is used. A starter 1 is configured to start, for example, an engine mounted on an automobile. The starter 1 includes a battery 2, an auxiliary relay 3, and an electromagnetic switch device 4. The auxiliary relay 3 is electrically connected to the battery 2. The electromagnetic switch device 4 is electrically connected to each of the battery 2 and the auxiliary relay 3. The electromagnetic switch device 4 according to the first embodiment of this invention serves as a starter electromagnetic switch device used for the starter 1.

Further, the starter 1 includes a motor 5, a pinion 6, and a lever 7. The motor 5 receives a current supplied from the battery 2 via the electromagnetic switch device 4. The pinion 6 is rotated by the driving of the motor 5. The lever 7 is configured to move the pinion 6. The pinion 6 moves between a meshing position and a release position. The meshing position is a position for allowing the pinion 6 to mesh with a ring gear 9 connected to an engine 8. The release position is a position for allowing the pinion 6 to be apart from the ring gear 9. When the pinion 6 is in the meshing position, the engine 8 is started by the driving of the motor 5.

The battery 2 is a DC power source. The battery 2 is electrically connected to the electromagnetic switch device 4 via the auxiliary relay 3. The current is supplied from the battery 2 to the electromagnetic switch device 4. The supply of the current from the battery 2 to the motor 5 may be via the auxiliary relay 3 or not via the auxiliary relay 3.

With the auxiliary relay 3, the state of the electromagnetic switch device 4 is switched between an ON state and an OFF state. A start signal is sent to the auxiliary relay 3 from a control device (not shown) in accordance with a key operation by a driver or a button operation by the driver. When the auxiliary relay 3 receives the start signal, the auxiliary relay 3 is closed. When the auxiliary relay 3 is closed, the current is supplied from the battery 2 to the electromagnetic switch device 4 via the auxiliary relay 3. The case in which the current is supplied to the electromagnetic switch device 4 is the ON state. When the auxiliary relay 3 is opened, the supply of the current from the battery 2 to the electromagnetic switch device 4 via the auxiliary relay 3 is stopped. The state in which the supply of the current to the electromagnetic switch device 4 is stopped is the OFF state.

The electromagnetic switch device 4 mainly has two functions. The first function of the electromagnetic switch device 4 is a function for moving the pinion 6 via the lever 7. The second function of the electromagnetic switch device 4 is a function for switching electric circuits for supplying the current from the battery 2 to the motor 5, between a main electric circuit 10 through which the current supplied to the motor 5 flows during the normal operation of the motor 5 and a starting electric circuit 11 through which the current supplied to the motor 5 flows during the start operation of the motor 5. The first function and the second function of the electromagnetic switch device 4 are interlocked with each other.

In FIG. 1, the electromagnetic switch device 4 is shown surrounded by a broken line. The electromagnetic switch device 4 includes a pair of main electric contacts 12 configured to open and close the main electric circuit 10 and a pair of starting electric contacts 13 configured to open and close the starting electric circuit 11.

Further, the electromagnetic switch device 4 includes a plunger 14, a holding coil 15 configured to generate a magnetic field, and a suction coil 16 configured to generate a magnetic field. Further, the electromagnetic switch device 4 includes a movable contact 17 configured to open and close each of the main electric contacts 12 and the starting electric contacts 13, and a rod 18 configured to move the movable contact 17. The plunger 14, the movable contact 17, and the rod 18 are moving parts of the electromagnetic switch device 4.

Each of the main electric contacts 12 and the starting electric contacts 13 are electric contacts which are opened and closed by the movable contact 17. The main electric circuit 10 is opened and closed by opening and closing the main electric contacts 12. During the normal operation of the motor 5, the current is supplied from the battery 2 to the motor 5 by the main electric circuit 10. The starting electric circuit 11 is opened and closed by opening and closing the starting electric contacts 13. During the start operation of the motor 5, the current is supplied from the battery 2 to the motor 5 by the starting electric circuit 11. When the starting electric circuit 11 is closed, the current is supplied to the suction coil 16 and the holding coil 15. When the starting electric circuit 11 is opened, the supply of the current to the suction coil 16 is stopped, and the supply of the current to the holding coil 15 is continued.

The starting electric contacts 13 are closed when the starter 1 is not operating and during the start operation of the motor 5. The electromagnetic switch device 4 includes the main electric contacts 12, the starting electric contacts 13, the plunger 14, the holding coil 15, the suction coil 16, the movable contact 17, and the rod 18. The electromagnetic switch device 4 may include the auxiliary relay 3.

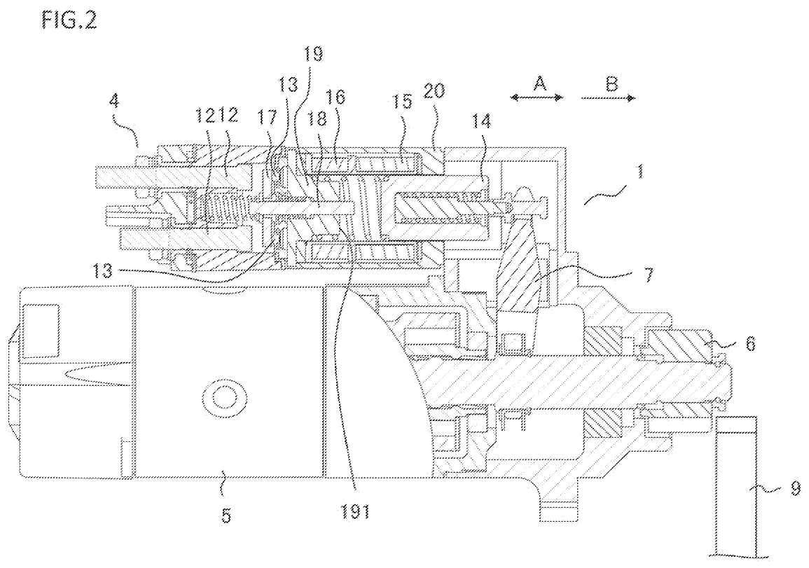

FIG. 2 is a cross-sectional view for illustrating a main part of the starter 1 of FIG. 1. The electromagnetic switch device 4 further includes a fixed iron core 19 and a case 20. The case 20 has a cylindrical shape and covers the fixed iron core 19 and the plunger 14. Each of the plunger 14, the fixed iron core 19, and the case 20 is made of a magnetic material.

The plunger 14 is configured to move between a contact position and a separation position. The contact position is a position for allowing the plunger 14 to be in contact with the fixed iron core 19. The separation position is a position for allowing the plunger 14 to be apart from the fixed iron core 19. The holding coil 15 and the suction coil 16 are arranged in such a manner as to be adjacent to each other in a moving direction “A” of the plunger 14. The axial direction of the case 20 matches the moving direction “A” of the plunger 14. Therefore, the holding coil 15 and the suction coil 16 are arranged in such a manner as to be adjacent to each other in the axial direction of the case 20.

With the current supplied to the suction coil 16, the suction coil 16 generates the magnetic field configured to move the plunger 14 from the separation position toward the contact position. With the current supplied to the holding coil 15, the holding coil 15 generates the magnetic field configured to move the plunger 14 from the separation position toward the contact position and the magnetic field configured to keep the plunger 14 in the contact position.

The holding coil 15 is arranged in such a manner as to deviate, in the moving direction “A” of the plunger 14, with respect to a contact surface 191 of the fixed iron core 19 with which the plunger 14 comes into contact. In this example, the holding coil 15 is arranged in such a manner as to deviate from the contact surface 191 in a separation direction “B” which is a direction in which the plunger 14 moves from the contact position to the separation position. The suction coil 16 is arranged in such a manner as to surround the fixed iron core 19.

When the supply of the current to each of the suction coil 16 and the holding coil 15 is stopped, a gap between the fixed iron core 19 and the plunger 14 is arranged inside both the suction coil 16 and the holding coil 15.

Next, the operation of the electromagnetic switch device 4 is described. When a start signal is sent from the control device to the starter 1, the current is supplied from the battery 2 to the holding coil 15 and the suction coil 16 via the auxiliary relay 3. With this, each of the holding coil 15 and the suction coil 16 generates the magnetic field. The strength of the magnetic field generated by the holding coil 15 is calculated by multiplying the number of turns of the holding coil 15 by the current flowing through the holding coil 15. The strength of the magnetic field generated by the suction coil 16 is calculated by multiplying the number of turns of the suction coil 16 by the current flowing through the suction coil 16.

With the current supplied to the holding coil 15 and the suction coil 16, the holding coil 15 and the suction coil 16 generate the magnetic field configured to move the plunger 14 from the separation position to the contact position. As a result, a suction force that is a force for moving the plunger 14 toward the fixed iron core 19 acts on the plunger 14.

The suction force of the suction coil 16 and the holding coil 15 causes the plunger 14 to move from the separation position to the contact position. When the movement of the plunger 14 is started, the plunger 14 first comes into contact with the rod 18. When the plunger 14 comes into contact with the rod 18, the rod 18 moves the movable contact 17. With the movement of the movable contact 17, the starting electric circuit 11 is opened. When the starting electric circuit 11 is opened, the supply of the current to the suction coil 16 is stopped. At this time, the supply of the current to the holding coil 15 is continued. When the supply of the current to the suction coil 16 is stopped, the magnetic field by the suction coil 16 is not generated. Therefore, the suction force by the holding coil 15 acts on the plunger 14.

After that, the suction force by the suction coil 16 causes the plunger 14 to move from the separation position to the contact position. With this, the rod 18 moves further. As the rod 18 moves further, the movable contact 17 moves further. As the movable contact 17 moves further, the main electric contacts 12 are closed. With the main electric contacts 12 closed, the supply of the current to the motor 5 via the main electric circuit 10 is started.

Further, as the plunger 14 moves from the separation position toward the contact position, the plunger 14 comes into contact with the contact surface 191 of the fixed iron core 19. With this, the plunger 14 is brought to the position corresponding to the contact position, and then the plunger 14 stops. When the plunger 14 comes into contact with the fixed iron core 19, the plunger 14 collides with the fixed iron core 19. With the plunger 14 colliding with the fixed iron core 19, an impact force is generated between the plunger 14 and the fixed iron core 19.

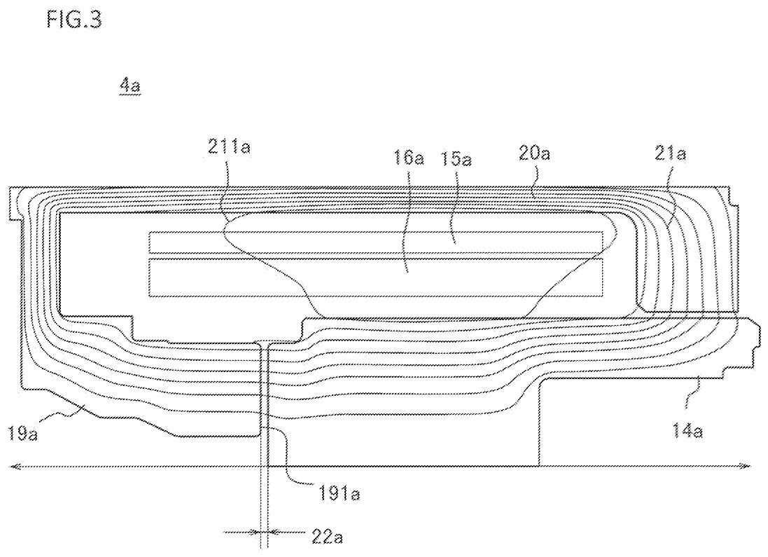

FIG. 3 is a diagram for showing a magnetic flux generated by a holding coil 15a in an electromagnetic switch device 4a of a comparative example immediately before a plunger 14a collides with a fixed iron core 19a. In the electromagnetic switch device 4a of the comparative example, the holding coil 15a is arranged on the same plane as a contact surface 191a. Therefore, among magnetic fluxes 21a emitted from the plunger 14a, a leakage flux 211a, which is a magnetic flux returning to the plunger 14a without passing through a gap 22a between the plunger 14a and the fixed iron core 19a, is small. In other words, there is a large amount of magnetic fluxes 21 passing through the gap 22a between the plunger 14a and the fixed iron core 19a. Therefore, the plunger 14a hits the fixed iron core 19a with a large suction force. As a result, the impact force to be generated between the plunger 14a and the fixed iron core 19a is large.

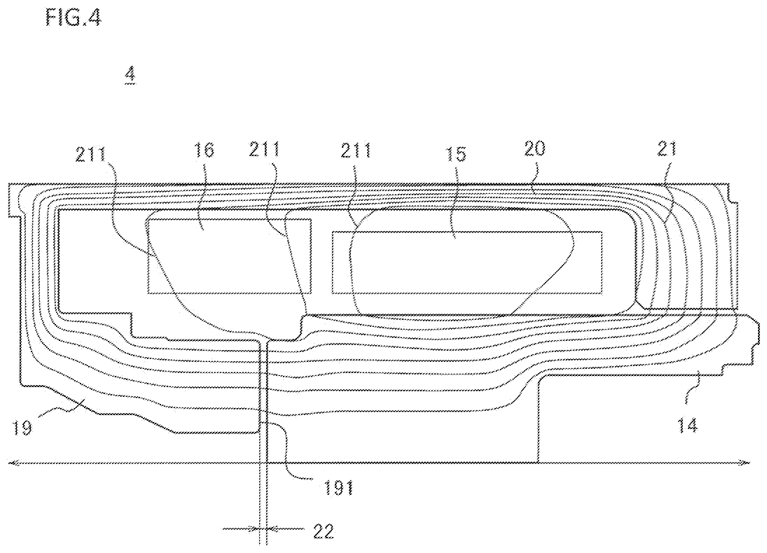

FIG. 4 is a diagram for showing the magnetic flux generated by the holding coil 15 in the electromagnetic switch device 4 of FIG. 2 immediately before the plunger 14 collides with the fixed iron core 19. In the electromagnetic switch device 4 according to the first embodiment, the holding coil 15 is arranged in such a manner as to deviate from the contact surface 191 in the moving direction “A” of the plunger 14. With this, among magnetic fluxes 21 emitted from the plunger 14, a leakage flux 211 which is a magnetic flux returning to the plunger 14 without passing through a gap 22 between the plunger 14 and the fixed iron core 19 increases. In other words, the magnetic flux passing through the gap 22 between the plunger 14 and the fixed iron core 19 is small. Therefore, the suction force which acts on the plunger 14 is reduced. As a result, the impact force to be generated between the plunger 14 and the fixed iron core 19 is reduced.

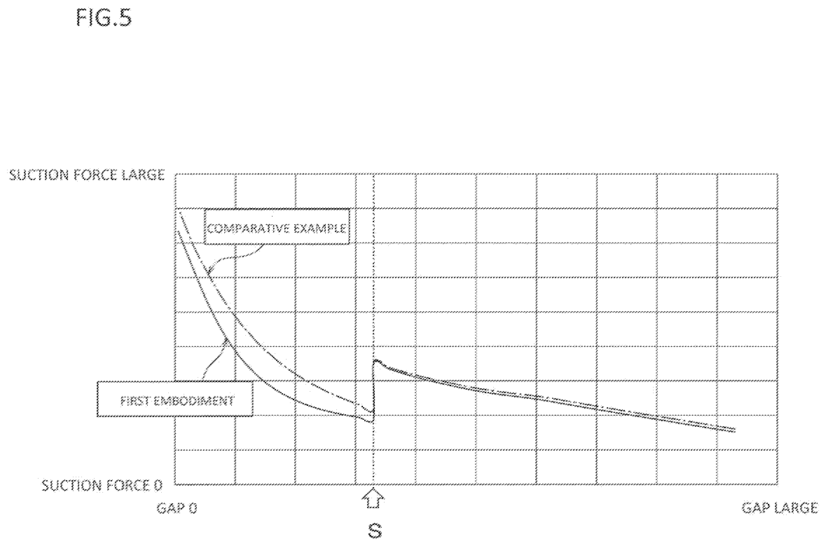

FIG. 5 is a graph for showing a relationship between the suction force and the gap in the electromagnetic switch device 4 of FIG. 2. In FIG. 5, the vertical axis represents the suction force which acts on the plunger 14, and the horizontal axis represents the dimension of the gap 22 between the plunger 14 and the fixed iron core 19. Further, in FIG. 5, the relationship between the suction force which acts on the plunger 14 and the gap 22 between the plunger 14 and the fixed iron core 19 in the electromagnetic switch device 4 according to the first embodiment is shown by a solid line. Further, in FIG. 5, the relationship between the suction force which acts on the plunger 14a and the gap 22a between the plunger 14a and the fixed iron core 19a in the electromagnetic switch device 4a of the comparative example is shown by a dashed line.

When the dimension of the gap 22 is “S”, the starting electric circuit 11 is opened. That is, when the dimension of the gap 22 is “S”, the plunger 14 comes into contact with the rod 18, and the movable contact 17 separates from the starting electric contacts 13. With this, the starting electric circuit 11 is opened, and the supply of the current to the suction coil 16 is stopped. After this, from the time when the starting electric circuit 11 is opened until the gap 22 disappears, the magnetic fluxes passing through the gap 22 are only those by the magnetic field generated by the holding coil 15. Therefore, at this timing, the suction force which acts on the plunger 14 decreases.

Then, the magnetic field generated by only the holding coil 15 causes the suction force to act on the plunger 14, and the plunger 14 moves from the separation position to the contact position. As shown in FIG. 5, when the dimension of the gap 22 is smaller than “S”, the suction force which acts on the plunger 14 in the electromagnetic switch device 4 according to the first embodiment becomes smaller than the suction force which acts on the plunger 14a in the electromagnetic switch device 4a of the comparative example. Therefore, the impact force to be generated between the plunger 14 and the fixed iron core 19 when the plunger 14 comes into contact with the fixed iron core 19 is reduced.

When the plunger 14 is brought to the position corresponding to the contact position, the position of the plunger 14 is kept in the contact position by the magnetic field generated by only the holding coil 15. As described above, the operation of the electromagnetic switch device 4 is completed.

As described above, with the electromagnetic switch device 4 according to the first embodiment of this invention, the holding coil 15 is arranged in such a manner as to deviate, in the moving direction “A” of the plunger 14, with respect to the contact surface 191 of the fixed iron core 19 with which the plunger 14 comes into contact. With this, the amount of the magnetic fluxes 21 passing through the gap 22 between the plunger 14 and the fixed iron core 19 is reduced immediately before the plunger 14 comes into contact with the fixed iron core 19. With this, the suction force for moving the plunger 14 toward the fixed iron core 19 is reduced immediately before the plunger 14 comes into contact with the fixed iron core 19. As a result, the impact force to be generated between the plunger 14 and the fixed iron core 19 when the plunger 14 comes into contact with the fixed iron core 19 can be reduced.

Further, in the electromagnetic switch device 4, when the starting electric circuit 11 is closed, the current is supplied to the suction coil 16 and the holding coil 15. When the starting electric circuit 11 is opened, the supply of the current to the suction coil 16 is stopped, and the supply of the current to the holding coil 15 is continued. With this, the amount of the magnetic fluxes 21 passing through the gap 22 between the plunger 14 and the fixed iron core 19 is reduced immediately before the plunger 14 comes into contact with the fixed iron core 19. As a result, the impact force to be generated between the plunger 14 and the fixed iron core 19 when the plunger 14 comes into contact with the fixed iron core 19 can be reduced.

Further, the holding coil 15 is arranged in such a manner as to deviate from the contact surface 191 in the separation direction “B” which is the direction in which the plunger 14 moves from the contact position to the separation position. With this, the plunger 14 can be arranged inside the holding coil 15.

Further, when the supply of the current to both of the suction coil 16 and the holding coil 15 is stopped, the gap 22 between the fixed iron core 19 and the plunger 14 is arranged inside both the suction coil 16 and the holding coil 15. With this, the amount of the magnetic fluxes 21 passing through the gap 22 can be increased when the supply of the current to the suction coil 16 and the holding coil 15 is started. As a result, the suction force which acts on the plunger 14 when the supply of the current to the suction coil 16 and the holding coil 15 is started can be increased.

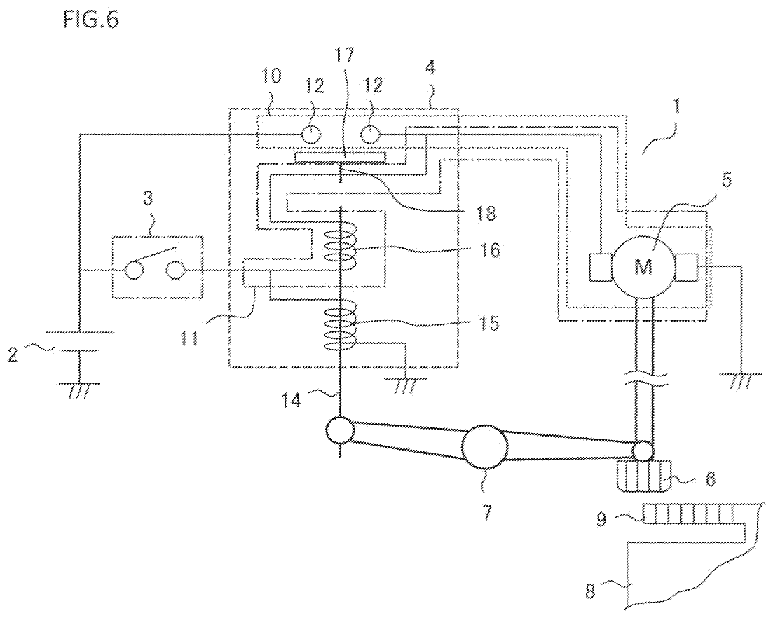

In the first embodiment, description has been given of the configuration in which the electromagnetic switch device 4 includes both the main electric contacts 12 and the starting electric contacts 13. However, as shown in FIG. 6, the electromagnetic switch device 4 may have the configuration in which the starting electric contacts 13 are omitted. In this case, the suction coil 16 is electrically connected to the motor 5. Until the main electric contacts 12 are closed, the current is supplied to the motor 5 via the starting electric circuit 11. Therefore, the current is supplied to the suction coil 16 and the holding coil 15 until the main electric contacts 12 are closed. When the main electric contacts 12 are closed, the potential difference between both ends of the suction coil 16 becomes almost zero. Therefore, in this case, the supply of the current to the motor 5 via the starting electric circuit 11 is stopped. As a result, the supply of the current to the suction coil 16 is stopped, and the supply of the current to the holding coil 15 is continued. When the supply of the current to the suction coil 16 is stopped, the magnetic field by the suction coil 16 is not generated. After that, the suction force by the suction coil 16 causes the plunger 14 to move from the separation position toward the contact position.

### REFERENCE SIGNS LIST

1 starter, 2 battery, 3 auxiliary relay, 4, 4a electromagnetic switch device, 5 motor, 6 pinion, 7 lever, 8 engine, 9 ring gear, 10 main electric circuit, 11 starting electric circuit, 12 main electric contact, 13 starting electric contact, 14, 14a plunger, 15, 15a holding coil, 16, 16a suction coil, 17 movable contact, 18 rod, 19, 19a fixed iron core, 20 case, 21, 21a magnetic flux, 22, 22a gap, 191, 191a contact surface, 211, 211a leakage flux.

1. An electromagnetic switch device, comprising:
a fixed iron core;
a plunger configured to move between a contact position and a separation position, the contact position being a position for allowing the plunger to be in contact with the fixed iron core, the separation position being a position for allowing the plunger to be apart from the fixed iron core;
a suction coil configured to generate, with a current supplied thereto, a magnetic field configured to move the plunger from the separation position toward the contact position; and
a holding coil configured to generate, with a current supplied thereto, a magnetic field configured to move the plunger from the separation position toward the contact position and a magnetic field configured to keep the plunger in the contact position,
wherein the holding coil is arranged in such a manner as to deviate, in a moving direction of the plunger, with respect to a contact surface of the fixed iron core with which the plunger comes into contact.

2. The electromagnetic switch device according to claim 1, further comprising a main electric contact configured to open and close a main electric circuit through which a current supplied to a motor flows during a normal operation of the motor,
wherein, when the main electric circuit is closed, the supply of the current to the suction coil is stopped, and the supply of the current to the holding coil is continued.

3. The electromagnetic switch device according to claim 1, further comprising a starting electric contact configured to open and close a starting electric circuit through which a current supplied to the motor flows during a start operation of the motor,
wherein, when the starting electric circuit is closed, the current is supplied to the suction coil and the holding coil, and
wherein, when the starting electric circuit is opened, the supply of the current to the suction coil is stopped, and the supply of the current to the holding coil is continued.

4. The electromagnetic switch device according to claim 1, wherein the holding coil is arranged in such a manner as to deviate with respect to the contact surface in a separation direction in which the plunger moves from the contact position to the separation position.

5. The electromagnetic switch device according to claim 1, wherein when the supply of the current to both the suction coil and the holding coil is stopped, a gap between the fixed iron core and the plunger is arranged inside both the suction coil and the holding coil.

6. The electromagnetic switch device according to claim 2, wherein the holding coil is arranged in such a manner as to deviate with respect to the contact surface in a separation direction in which the plunger moves from the contact position to the separation position.

7. The electromagnetic switch device according to claim 3, wherein the holding coil is arranged in such a manner as to deviate with respect to the contact surface in a separation direction in which the plunger moves from the contact position to the separation position.

8. The electromagnetic switch device according to claim 2, wherein when the supply of the current to both the suction coil and the holding coil is stopped, a gap between the fixed iron core and the plunger is arranged inside both the suction coil and the holding coil.

9. The electromagnetic switch device according to claim 3, wherein when the supply of the current to both the suction coil and the holding coil is stopped, a gap between the fixed iron core and the plunger is arranged inside both the suction coil and the holding coil.

10. The electromagnetic switch device according to claim 4, wherein when the supply of the current to both the suction coil and the holding coil is stopped, a gap between the fixed iron core and the plunger is arranged inside both the suction coil and the holding coil.

11. The electromagnetic switch device according to claim 6, wherein when the supply of the current to both the suction coil and the holding coil is stopped, a gap between the fixed iron core and the plunger is arranged inside both the suction coil and the holding coil.

12. The electromagnetic switch device according to claim 7, wherein when the supply of the current to both the suction coil and the holding coil is stopped, a gap between the fixed iron core and the plunger is arranged inside both the suction coil and the holding coil.
